(19) United States
(12) Patent Application Publication
(10) Pub. No.: US 2009/0177579 A1
(43) Pub. Date: Jul. 9, 2009

(54) Transaction System Supporting Dynamic Currency Conversion

(75) Inventor: James Ling, St. Leonards (AU)

Correspondence Address: SCHWEGMAN, LUNDBERG & WOESSNER, P.A., P.O. BOX 2938, MINNEAPOLIS, MN, 55402, US

(73) Assignee: Travelex Outsourcing Pty Limited, melbourne, Victoria (AU)

(21) Appl. No.: 12/226,795

(22) PCT Filed: May 15, 2007
(86) PCT No.: PCT/AU2007/000654

§ 371 Date: Oct. 28, 2008

(30) Foreign Application Priority Data
May 16, 2006 (AU) 2006902601

(51) Int. Cl. G06Q 40/00

(52) U.S. Cl. 705/39; 705/35

(57) ABSTRACT

Disclosed is a method of performing a funds transaction that includes providing the option to perform the transaction using dynamic currency conversion and apparatus for performing dynamic currency conversion. The method may include identifying whether a transaction is eligible for dynamic currency conversion and if so allowing an operator to enter a nominated currency and subsequently conducting the transaction in the nominated currency. Otherwise the transaction may be performed in a default currency.

### TECHNICAL FIELD

The present invention relates to transaction systems for use in multi-currency environments that allow transactions to be conducted in one or more currencies. The invention also relates to methods of conducting dynamic currency conversions, either in whole or in part.

### BACKGROUND OF THE INVENTION

FIG. 1 shows a block diagram representative of the entities that may be involved in a card payment system and the information transfer between those entities in a typical card payment system.

A cardholder 1 obtains a transaction card 6 from an issuer 4. The issuer 4 may typically be a retail banking or financial institution. Issuers 4 provide transaction cards 6 for use at point of sale (POS) terminals 7 located at merchants 2. Transactions initiated at POS terminals 7 are acquired and processed by acquirers 3 via card scheme administrators 5. Examples of current card schemes include the MasterCard International, VISA International, Diners Club and American Express schemes.

The cardholder 1 uses their transaction card 6 to make a financial transaction at a merchant 2. For example, where the cardholder 1 is the holder of a credit card, they may swipe their card through a point of sale (POS) terminal 7 provided at the premises of a merchant 2. The POS terminal 7 extracts account details from the transaction card 6, including the card number that identifies the financial account of the cardholder 1 with the relevant financial institution (i.e. the issuer 4).

The POS terminal 7 is connected or connectable to a network 8. For example, smaller scale merchants 2 may connect to the network 8 through a dial-up connection to a PSTN network. Alternative public or private local and/or wide area networks based on industry standard or proprietary wired or wireless technologies and network connections may be used for central handling of transactions. The account details and particulars of the transaction are then sent to and are received by an acquirer 3. The particulars of the transaction may include the ID of the POS terminal 7, the ID of the merchant 2, the number of the transaction card 6, the value of the requested transaction and the currency of the requested transaction.

Upon receipt of the transaction particulars, the acquirer 3 sorts the transactions into groups according to the card scheme and sends the transactions relating to a card scheme to the appropriate card scheme administrator 5 (one only shown in FIG. 1). The first digits of the transaction card 6 number typically identify the card scheme.

The card scheme administrator 5 then sorts the transactions that it receives by the issuer 4 of the transaction card 6. This may be achieved by examining the BIN number, which is often the first six digits of the credit card. Each issuing bank is assigned one or more BIN numbers, so that all cards issued by that issuer 4 commence with one of those BIN numbers.

Upon receipt of the transaction particulars, the issuer 4 sends back a response to the card scheme administrator 5. The card scheme administrator 5 forwards this response to the acquirer 3, who in turn returns the response to the POS terminal 7 with an authorisation code.

If the transaction has been successful, the issuer 4 then manages the transfer of funds between the account of the cardholder 1 and the card scheme administrator 5. The card scheme administrator 5 transfers the funds to the acquirer 3 who then settles the funds with the merchant 2. The acquirer 3 sends a statement of account to the merchant 2 and the issuer sends a statement of account to the cardholder 1. Often an acquirer 3 is also an issuer 4.

Where the local currency of a merchant 2 does not match the local currency of a cardholder 1, for example where the cardholder 1 has traveled overseas, the cardholder 1 may have difficulty appreciating the true value of the transaction. This is because traditionally the transaction is made in the currency of the merchant 2, with the card scheme administrator 5 attending to the necessary foreign exchange. This identified problem lead to the development of Dynamic Currency Conversion (DCC).

DCC allows a cardholder 1 to conduct a transaction at a merchant 2 in their local currency instead of the local currency of the merchant 2. A fee may be charged for the service. The advantage of DCC, if used in the right circumstances, is that the cardholder 1 can see the exact value that will appear in their statement of account from their respective issuer 4 at the time of the transaction. In DCC transactions, it is the acquirer 3 that attends to the necessary foreign exchange, instead of the card scheme administrator 5.

One method of completing a DCC transaction is for the POS terminal 7 to look up a table that lists the BIN number of cards and the associated local currency. A problem with implementing DCC in this manner is that it requires a POS terminal 7 with processing and display capabilities beyond those of many POS terminals 7 that are currently in use. Also, the table of BIN numbers inside the POS terminal 7 must be kept up to date to ensure that the cardholder 1 is offered the correct currency. Another problem from the perspective of the provider of DCC is that there is often no obligation on the merchant to offer the option of performing the transaction in the local currency of the cardholder 1. A still further problem arises when the local currency of the cardholder 1 does not match the currency that he or she is billed in by the card scheme administrator 5, which leads to additional foreign exchange charges that the cardholder 1 may not be expecting.

For e-commerce applications, a transaction system having a similar structure to that shown in FIG. 1 may be used, with the POS terminal 7 replaced by an alternative transaction terminal, for example a personal computer, mobile phone, personal digital assistant or other similar device, which may communicate with the system of a merchant 2 through a communication channel.

### SUMMARY OF THE INVENTION

According to a first aspect of the present invention, there is provided a method of performing a funds transaction that includes providing the option to perform the transaction using dynamic currency conversion, the method comprising the steps of:

at a transaction terminal, receiving information that identifies an account and/or related information to an account;

using said information, determining whether the transaction is eligible for dynamic currency conversion;

if the transaction is eligible for dynamic currency conversion conducting the transaction in a nominated currency entered by an operator of the transaction terminal using an input device of the transaction terminal;

if the transaction is not eligible, performing the transaction in a default currency.

In one embodiment the method further includes requiring the operator of the transaction terminal to specify whether or not dynamic currency conversion is to be performed before allowing the transaction to proceed.

In one embodiment the default currency is the nominated currency of a merchant operator of the transaction terminal.

In one embodiment, at least part of the information that identifies an account and/or related information to the account is information either read by a reader of the transaction terminal or entered by the operator of the transaction terminal and the process of determining whether the transaction is eligible for dynamic currency conversion includes determining whether the card is issued by a domestic issuer and determining the transaction as not eligible if the card is issued by a domestic issuer.

In one embodiment, the method further comprises requiring the cardholder to specify the nominated currency.

In one embodiment the process of determining whether the transaction is eligible for dynamic currency conversion includes determining whether:

i) the nominated currency is the same as a billing currency of the card; and

ii) the billing currency of the card is supported,

wherein the transaction is determined to be not eligible if either i) or ii) is not satisfied.

According to a second aspect of the present invention, there is provided apparatus for performing a dynamic currency conversion transaction, the apparatus comprising a transaction terminal including a user interface, means to receive an identifier related to an account of a cardholder, and a communication interface for communicating with a network, wherein the transaction terminal receives an identifier from the means to receive an account identifier and then:

a) either:
i) using the communication interface transmits particulars of a transaction and receives a communication reporting whether the transaction is eligible for dynamic currency conversion, and/or
ii) compares the account identifier with a listing of account identifiers maintained in memory and determines from the listing whether the transaction is eligible for dynamic currency conversion;

b) if the transaction is eligible for dynamic currency conversion and an input to the user interface indicates that dynamic currency conversion is required, initiates processing of the transaction in a nominated currency, wherein the nominated currency has been received as an input to the user interface of the terminal;

c) if the transaction is not eligible for dynamic currency conversion or if an input to the user interface indicates that dynamic currency conversion is not required, initiates processing of the transaction in a default currency.

In one embodiment, processes b) and c) require receipt of an input from the user interface indicating whether dynamic currency conversion is required before processing the transaction.

In one embodiment, the transaction terminal compares the account identifier with a listing of account identifiers maintained in memory and determines from the listing whether the transaction is eligible for dynamic currency conversion and wherein the step of determining comprises comparing the account identifier with a list of domestic issuers stored in the memory and if there is a match with any entry in the list, determining that the transaction is not eligible for dynamic currency conversion.

In one embodiment, the transaction terminal compares the account identifier with a listing of account identifiers maintained in memory and determines from the listing whether the transaction is eligible for dynamic currency conversion, wherein the transaction terminal stores in memory information identifying international issuers for which the billing currency of the issuer is a supported dynamic currency conversion currency, and wherein step of determining comprises determining whether the account identifier is associated with a said international issuer and if so determining that the transaction is eligible for dynamic currency conversion. In this embodiment if the account identifier is not associated with a said international issuer, the transaction terminal may require additional user input at the user interface. Also, the additional user input may be the identification of another nominated currency.

According to a third aspect of the present invention, there is provided apparatus for performing a dynamic currency conversion transaction, the apparatus comprising a computer in communication with a network, the computer operable to receive particulars of a transaction from a transaction terminal via said network, determine whether the transaction is eligible for dynamic currency conversion, and if so transmit onto the network data addressed to the transaction terminal a communication reporting whether the transaction is eligible for dynamic currency, the communication not including information identifying any particular country or currency.

In one embodiment, the computer determines whether the transaction is eligible for dynamic currency conversion by comparing an identifier of an account involved in the transaction with entries stored in computer memory. In this embodiment the entries stored in computer memory may list identifiers of accounts that are eligible for dynamic currency conversion due to the local currency of the account holder matching a billing currency of the account holder for the transaction. Also, the transaction particulars may include information identifying a nominated country or currency and the computer may determine whether the transaction is eligible for dynamic currency conversion by comparing the nominated country or currency with the local currency associated with the account holder.

According to a fourth aspect of the present invention, there is provided a method of operating a transaction terminal to facilitate dynamic currency conversion of a transaction, the method comprising:

receiving at the transaction terminal data identifying currencies accepted for dynamic currency conversion;

at a transaction terminal, receiving particulars of a requested transaction, including an amount of a transaction in a first currency and identification of another currency for the transaction, wherein the identification of the other currency is received via an operator interface of the transaction terminal;

in the transaction terminal determining whether the transaction is eligible for dynamic currency conversion, including comparing the other currency with the accepted currencies and if the transaction is eligible converting the amount of a transaction in the first currency into a transaction amount in the other currency, and transmitting data for completing the requested transaction onto a network, the transmitted data including the transaction amount in the other currency.

According to a fifth aspect of the present invention, there is provided a method of performing a funds transaction that includes providing the option to perform the transaction using dynamic currency conversion, the method including performing the following processes within a transaction terminal:

receiving account information identifying an account and/or related information to an account;

using the account information, determining whether the information identifies a domestic account and if the account information identifies a domestic account, performing the transaction in a default currency;

if the account information identifies an international account, determining whether the transaction is eligible for dynamic currency conversion;

if the transaction is eligible for dynamic currency conversion, causing the display on a display of the transaction terminal a dynamic currency conversion offer and monitoring an operator interface of the transaction terminal for an indication of whether the offer is accepted and if so facilitating completion of the transaction using dynamic currency conversion;

if the nominated currency is not supported or if the dynamic currency conversion offer is not accepted, performing the transaction in a default currency.

According to a sixth aspect of the present invention, there is provided apparatus for performing a dynamic currency conversion transaction, the apparatus comprising a transaction terminal including a user interface, means to receive an identifier related to an account of a cardholder, and a communication interface for communicating with a network, wherein the transaction terminal receives an identifier from the means to receive an account identifier and then:

a) compares the identifier with a listing of domestic accounts and performs the transaction in a default currency if the identifier is determined to be associated with a domestic account;

b) if process a) indicates that the identifier is not associated with a domestic account then either:
i) using the communication interface transmits particulars of a transaction and receives a communication reporting whether the transaction is eligible for dynamic currency conversion, and/or
ii) compares the account identifier with a listing of account identifiers maintained in memory and determines from the listing whether the transaction is eligible for dynamic currency conversion;

and if the transaction is eligible for dynamic currency conversion and an input to the user interface indicates that dynamic currency conversion is required, initiates processing of the transaction using dynamic currency conversion;

and if the transaction is not eligible for dynamic currency conversion or if an input to the user interface indicates that dynamic currency conversion is not required, initiates processing of the transaction in the default currency.

According to a seventh aspect of the present invention, there is provided a method of performing a transaction that includes providing the option to perform the transaction using dynamic currency conversion, the method comprising the steps of:

at a transaction terminal, receiving information that identifies an account and/or related information to an account; and

conducting the transaction in a nominated currency entered by an operator of the transaction terminal using an input device of the transaction terminal.

According to an eighth aspect of the present invention, there is provided apparatus for performing a dynamic currency conversion transaction, the apparatus comprising a transaction terminal including a user interface, means to receive an identifier related to an account of a cardholder, and a communication interface for communicating with a network, wherein the transaction terminal receives an identifier from the means to receive an account identifier and then initiates processing of the transaction in a nominated currency, wherein the nominated currency has been received as an input to the user interface of the terminal.

Further aspects of the present invention will become apparent from the following description, given by way of example only and with reference to the accompanying drawings.

### BRIEF DESCRIPTION OF THE DRAWINGS

FIG. 1: shows a block diagram representation of the entities involved in a known transaction network;

FIGS. 2a-2c: each show a flow chart of a transaction method according to an embodiment of the present invention; and

FIG. 3: shows a block diagram of a POS terminal and a representation of information that may be stored in the memory of the POS terminal.

### DETAILED DESCRIPTION

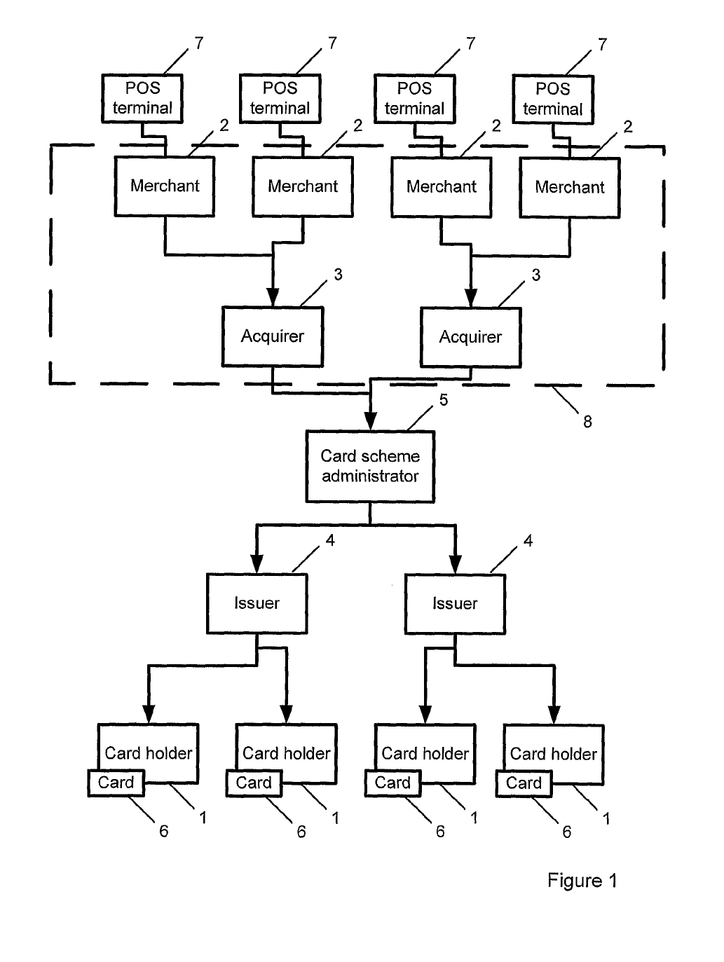

The present invention may be implemented in a transaction network of the type described herein in relation to FIG. 1 and the following description assumes that the invention has been implemented in such a transaction network and that the transaction system is a card payment system. However, the present invention may have application to other transaction networks and other payment systems.

For example, the present invention may also have application to e-commerce over a wide area network such as the internet, in which case the transaction terminal would be a personal computational device such as a personal computer, personal digital assistant, mobile phone, or other device. The invention may also be applied to automated teller machines (ATMs), in which case the transaction terminal is the ATM that the cardholder is using. The invention may also have application to transaction networks that are not card based, for example transaction networks that include the extraction of biometric or other information to identify some particulars of a transaction.

The examples provided below assume a context of a transaction at a merchant, where the primary operator of the transaction terminal is an employee or owner of the merchant. However, the person making the transaction (ie. cardholder 1) could be the primary or sole operator of the transaction terminal and this would be the most likely situation in many of the alternative applications of the present invention described above.

### Example 1

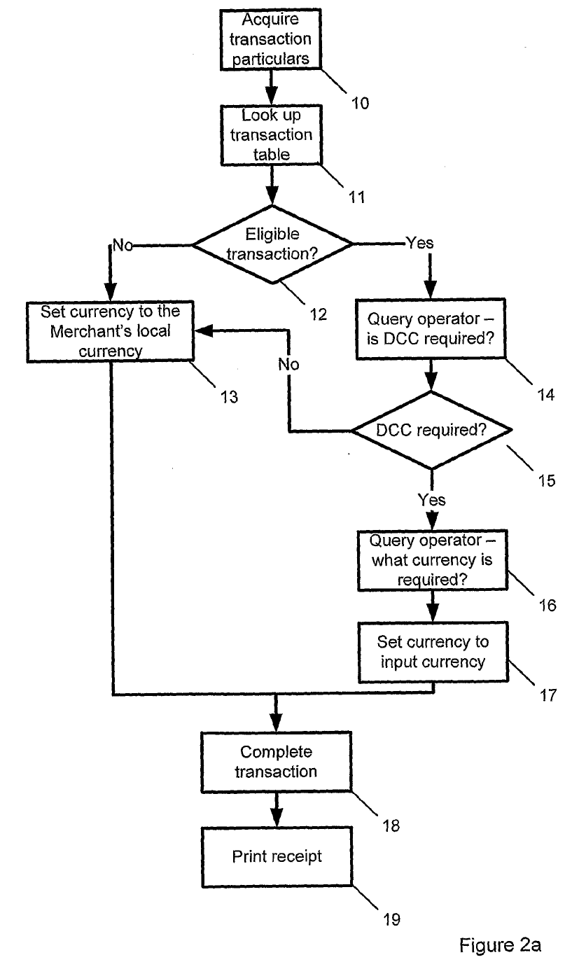

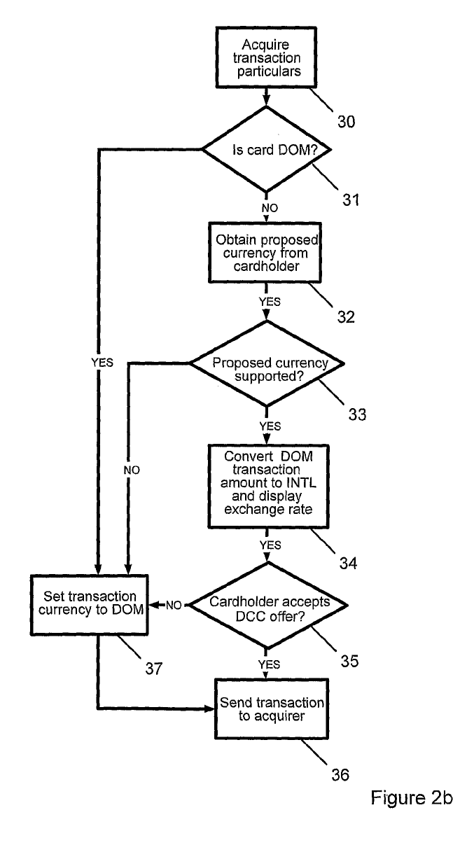

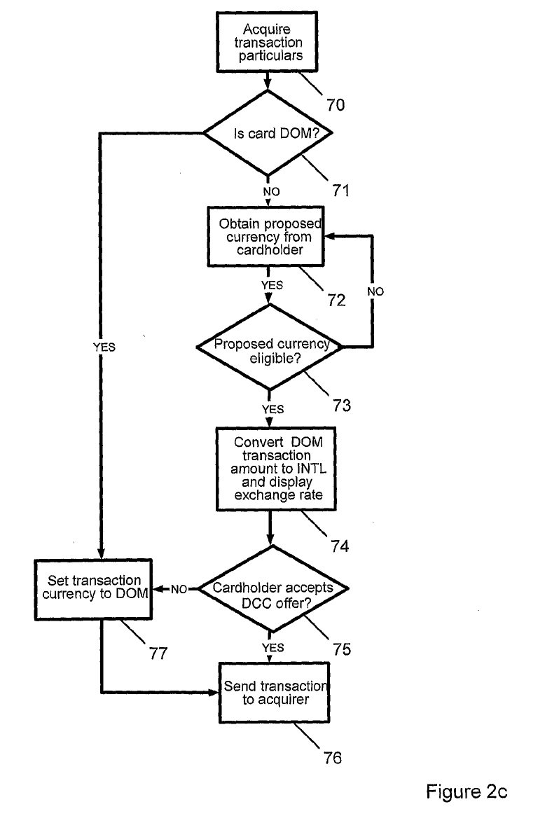

FIG. 2a shows a flow diagram of steps performed according to an exemplary method of the present invention. Those skilled in the relevant arts will appreciate that modifications to the method and the other example methods described herein may be made depending on how the transactions are managed, the entities involved in processing a transaction and the particular communication channel(s) used to communicate transaction data.

In step 10 particulars of a transaction are received from the POS terminal 7 of a merchant 2 by the system of an acquirer 3. As described herein above, the transaction particulars may include information identifying an account of a payor, for example a transaction account of the cardholder 1, the transaction amount and the identity of the merchant 2. In a card payment system, this information is usually acquired at a point of sale (POS) terminal by swiping a magnetic stripe card through a suitable reader, by inserting a smartcard into a smartcard reader or by passing an encoded card near a card proximity reader, and by entering or receiving the transaction value. At present, card payment systems represent the most widespread mode of conducting multi-currency transactions.

At the acquirer 3, in addition to the usual authorisation process, a check is made as to whether the transaction is eligible for dynamic currency conversion (DCC). An eligible transaction is one where the billing currency of the cardholder 1 is the same as their local currency and where the local currency is a currency accepted by the card scheme administrator 5 for settlement of the transaction. If currency conversion were allowed if these requirements were not met, the cardholder would be subjected to a double foreign exchange conversion fee. This double foreign exchange transaction can result in the cardholder 1 being charged an increased amount over what they expected from viewing the transaction amount at the POS terminal 7 at the merchant 2.

If it is determined that the transaction is not eligible for DCC, then the transaction is performed in the merchant's local currency and the transaction is completed in the usual manner at step 18, with a receipt showing details of the transaction provided to the cardholder 1 in step 19. Step 18 may require the cardholder 1 to accept a DCC offer, which shows the original amount in the merchant's local currency, the converted transaction amount, optionally together with or including any additional fees charged for foreign exchange.

If the transaction is deemed eligible for DCC, the POS terminal 7 queries the operator whether DCC is required (step 14). This may be achieved by a simple message displayed on a display of the POS terminal 7 that requests a yes or no answer, or by prompting the operator to ask the cardholder to nominate a preferred currency. In a preferred embodiment as presently contemplated, the operator must proceed through steps 14 and 15 for every transaction that is eligible for DCC. To determine whether DCC is required, the operator, which is usually an employee of the merchant 2, of the POS terminal 7 asks the cardholder 1 whether they would like their transaction to proceed in their local currency or refers to a sign that explains the options for selecting other preferred currencies in which to perform the transaction. The sign may be provided in several different languages to help overcome any language difficulties between the merchant 2 and cardholder 1.

If the operator indicates that DCC is required in step 15, the process proceeds to step 16. In step 16, the POS terminal queries the operator for an indication of the currency that is required. The operator asks the cardholder 1 what their local or preferred currency is and then enters the currency nominated by the cardholder 1. The operator or cardholder then may enter a currency code or other identifier into the terminal for that currency. The operator may be provided with a table listing the currencies eligible for DCC and their corresponding codes or identifiers.

The POS terminal 7 then looks up a table (or data formatted in another format) of exchange rates, including any margin that may be applied for providing DCC, and computes or looks up the value of the transaction in the entered currency. The table of exchange rates may be transmitted to the POS terminal 7, or stored on the system of the acquirer 3 or even the system of the card scheme administrator 5, in which case the POS terminal 7 would request the table look up or computation. An advantage of storing the table at the POS terminal 7 is that faster transaction processing may result due to reducing communications over the transaction network 8. An advantage of storing the table at the system of the acquirer 3 is that updates to the table can be made centrally rather than having to be distributed to each POS terminal 7.

The currency of the transaction is set to the currency identified (step 17) and the amount of the transaction in this currency is displayed on a display of the POS terminal 7. The transaction is then completed in step 18 using the currency set in step 17 and a receipt is printed in step 19. Preferably the receipt indicates the value of the transaction both in the default currency (the local currency of the merchant 2) and the currency set in step 17 (the local currency of the cardholder 1).

An advantage of the method described herein with reference to FIG. 2a is that it requires the merchant 2 to specifically nominate on the POS terminal 7 the currency that the transaction is to be processed in, as opposed to:

(1) offering the billing currency of the transaction card 6 which has been identified using the BIN number; or

(2) a choice between the identified billing currency and the local currency of the merchant 2.

Alternative methods of performing DCC typically use variations of (1) and (2) above, which suggest options to the cardholder rather than requiring an unbiased nomination. The method described ensures that the cardholder always makes an unbiased nomination without suggestion or influence. The method also minimises the possibility of the merchant 2 withholding the option of processing a DCC transaction (or conversely, processing in the local currency of the merchant 2 even though the cardholder indicated that he or she required DCC), rather than requiring the cardholder to nominate their preferred currency.

Another advantage is that method does not require a particularly sophisticated POS terminal 7. These and other advantages may also be achieved by using the methods and systems described in the following examples.

### Example 2

FIG. 2b shows a flow diagram of steps performed according to another exemplary method of the present invention.

In step 30 particulars of a transaction are received from the POS terminal 7 of a merchant 2 by the system of an acquirer 3 in the same manner as described in relation to step 10 of FIG. 2a.

In step 31, the transaction particulars are checked within the POS terminal 7 to determine if an issuer 4 that is a domestic (DOM) issuer has issued the transaction card 6. This may be performed by looking up a table that lists all of the BIN numbers of the DOM issuers. The table may be stored in the POS terminal 7. If a DOM issuer has issued the transaction card, then the transaction is not eligible for DCC and is processed in the local currency of the merchant 2 (steps 37 and 36). If not, then an issuer 4 that is an international (INTL) issuer has issued the transaction card 6, and the associated transaction is eligible for DCC. In this case, the POS terminal 7 prompts the operator (usually an employee of the merchant 2) to enquire of the cardholder 1 which currency they would like to process the transaction in. The operator may refer to a sign that explains the options. The sign may be provided in several different languages to help overcome any language difficulties between the merchant 2 and cardholder 1. The sign may be a physical sign, for example a card handed to the operator or used as a reference by the operator, or may be electronic, for example displayed on a display of the POS terminal 7 (or other transaction terminal). The operator enters the chosen currency to the POS terminal 7 (step 32). When the sign is displayed on a display of the terminal, the operator of the terminal, whether it is the cardholder 1 or the merchant 2 at the time, may select one option from a list of currencies.

In step 33, the POS terminal 7 sends the transaction particulars to the acquirer 3 to determine if the card scheme administrator 5 accepts the currency for settlement of the transaction. This may be determined by looking up a table containing a list of accepted currencies, or conversely a list of currencies that are not accepted. If the currency is accepted by the card scheme administrator 5, then in step 34 the transaction amount in the local currency of the merchant 2 is converted to the currency proposed by the cardholder 1, and the exchange rate and converted amount are returned to the POS terminal 7 for presentation to the cardholder 1 on the receipt printed by the POS terminal 7.

The exchange rate conversion is performed by using a table (or data formatted in another format) of exchange rates, including any margin that may be applied for providing DCC, and computes or looks up the value of the transaction in the proposed currency. The table of exchange rates may be transmitted to the POS terminal 7, or stored on the system of the acquirer 3 or even the system of the card scheme administrator 5. An advantage of storing the table at the POS terminal 7 is that faster transaction processing may result due to reducing communications over the transaction network 8. Like in the first example, an advantage of storing the table at the system of the acquirer 3 is that updates to the table can be made centrally.

If the outcome of step 33 is that the card scheme administrator 5 does not accept the currency for settlement of the transaction, then the process moves to step 37.

In step 35, the cardholder 1 decides whether or not to accept the DCC offer. If the cardholder 1 accepts, the transaction particulars are sent in step 36 to the acquirer 3 in the currency proposed by the cardholder 1 in step 32. If the cardholder 1 declines the DCC offer, the transaction particulars are set to reflect the local currency of the merchant 2 (step 37) and are sent to the acquirer 3 (step 36) in the usual manner. A receipt showing details of the transaction particulars is provided to the cardholder 1 in both cases.

### Example 3

Referring again to FIG. 2b, another exemplary method of the present invention has the same steps 30 to 37, but with a modified method of performing step 33.

In this alternative method, step 33 involves the POS terminal 7 sending the transaction particulars to the acquirer 3 to determine if i) the transaction card 6 billing currency is the same as the currency proposed by the cardholder 1 and ii) the card scheme administrator 5 accepts the proposed currency for settlement of the transaction. If yes, then in step 34 the transaction amount in the local currency of the merchant 2 is converted to the currency proposed by the cardholder 1, and the exchange rate and converted amount are returned to the POS terminal 7 for presentation to the cardholder 1 on the receipt printed by the POS terminal 7.

But if the outcome of step 33 is that the transaction card 6 billing currency is not the same as the currency proposed by the cardholder 1, or the card scheme administrator 5 does not accept the currency for settlement of the transaction, then step 37 is performed.

An advantage with this alternative method is that the test for eligibility is extended beyond simply confirming whether or not the card scheme administrator 5 accepts the proposed currency. It also includes confirming whether or not the billing currency of the transaction card 6 is the same as the currency proposed by the cardholder 1. This prevents double conversion from occurring, which would result in increased cost for the cardholder 1.

### Example 4

FIG. 2c shows a flow diagram of a further alternative exemplary method of the present invention. Except for the differences described herein below, steps 70 to 77 are the same as steps 30 to 37 of FIG. 2b.

The difference illustrated in the method shown in FIG. 2c over Example 2 described herein is also with step 73. In this alternative method, step 73 involves the POS terminal 7 sending the transaction particulars to the acquirer 3 to determine if i) the transaction card 6 billing currency is the same as the currency proposed by the cardholder 1 and ii) the card scheme administrator 5 accepts the proposed currency for settlement of the transaction. If yes, then in step 74 the transaction amount in the local currency of the merchant 2 is converted to the currency proposed by the cardholder 1, and the exchange rate and converted amount are returned to the POS terminal 7 for presentation to the cardholder 1 on the receipt printed by the POS terminal 7.

But if the outcome of step 73 is that the transaction card 6 billing currency is not the same as the currency proposed by the cardholder 1, or the card scheme administrator 5 does not accept the currency for settlement of the transaction, then step 72 is performed again.

Optionally, a counter may limit the number of cycles of steps 72 and 73 and either revert to step 77 or proceed to step 74 with the latest choice of currency if a threshold value is reached. In an embodiment where the process proceeds to step 74, the threshold value for the counter may be one, so that the process conducts the transaction in the second selected currency even if it does not meet the eligibility criteria described herein that should be met to avoid a plurality of foreign exchanges. Also, or instead, each time a “NO” cycle out of step 73 occurs, the operator may be given the option to either conduct the transaction in the local currency or enter another currency choice. If the operator chooses the local currency, then the method proceeds to step 77 and if the operator chooses to enter another currency choice, then step 72 is repeated.

An advantage with this alternative exemplary method is that if the test for eligibility is not passed, the cardholder 1 is provided with the opportunity to select another currency. This provides the cardholder 1 with at least one further opportunity to process the transaction in a proposed currency other than the local currency of the merchant 2 (i.e. to perform a DCC transaction).

### Further Alternative Embodiments

In these embodiments, the operator of the POS Terminal 7 or transaction terminal may also be either be an operator of the merchant 2 or the cardholder 1 in a self-service environment.

In alternative embodiments, step 12 from the process described in FIG. 2a, step 33 from the processes described in relation to FIG. 2b and step 73 from the process described in relation to FIG. 2c may be omitted.

Therefore, in one such alternative embodiment, the process in FIG. 2a would proceed directly from step 11 to step 14. In a further variation, the process in FIG. 2a may proceed directly from step 11 to step 16, in which case all transactions require the operator of the transaction terminal to select a currency. This variation may have particular application to a merchant 2 that has an international client base, for example an online retail store with international sales coverage.

Similarly, the processes described in relation to FIG. 2b would proceed from step 32 directly to step 34 and the process described in relation to FIG. 2c would proceed from 72 directly to step 74.

In these embodiments, the transaction is performed in whatever currency is selected by the cardholder 1. Accordingly, in these embodiments and any other embodiment that allows a transaction to proceed in a currency other than the local currency of the merchant 2 or an eligible currency, the display of the POS terminal 7 or another sign at the terminal may explain that if a currency is selected that does not meet the eligibility criteria described previously herein, then a plurality of foreign exchange transactions may be required, which may lead to an increased total transaction cost when the exchange fees are included.

In still further alternative embodiments, step 31 may be omitted from the processes described in relation to FIG. 2b and step 71 may be omitted from the processes described in relation to FIG. 2c. In this embodiment a currency must be selected by the operator of the POS terminal 7 for all transactions. These embodiments may also have particular application to a merchant 2 that has an international client base, for example an online retail store with international sales coverage. Accordingly, in one embodiment both steps 31 and 33 may be omitted from the processes described in relation to FIG. 2b and both steps 71 and 73 may be omitted from the processes described in relation to FIG. 2c.

Configurable Transaction Terminal

In one embodiment, software may be provided for a transaction terminal that is configured to operate in two or more of the embodiments described herein in relation to FIGS. 2a-2c. The operator of the terminal or supplier of the software may then choose which method to implement, for example when setting up a POS terminal 7 or web server for e-commerce transactions. Alternatively, the choice of which method to implement may be made by a supplier when downloading the software to the terminal if this option is provided.

The POS Terminal

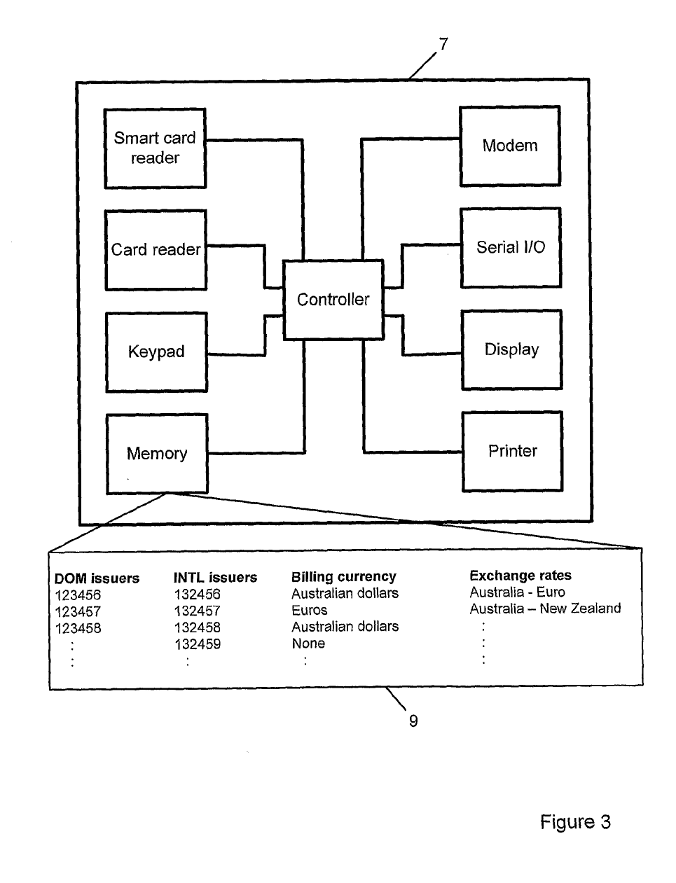

FIG. 3 shows a block diagram of an exemplary POS terminal 7. The POS terminal 7 includes a controller, which may for example be a 32 bit microprocessor, that controls operation of the POS terminal 7. The controller receives transaction particulars from a smart card reader, card reader and/or keypad. The POS terminal includes a display to present information to the operator of the terminal, a printer that may print receipts, and an Input/Output port to allow wired or wireless communication with other devices located at the premises of the merchant 2. As discussed herein, the POS terminal 7 transmits and receives information via a modem or other networking communications system or device.

The POS terminal 7 includes a memory, which includes a RAM and ROM component; the instructions that control operation of the controller of the POS terminal 7 stored in ROM. With particular reference to Examples 3 and 4 where the POS terminal 7 is provided with all the required information to perform a transaction apart from an authorisation code for a transaction, the RAM may store a list of current domestic (DOM) issuers of cards. As previously described, the DOM issuers can be identified by the BIN number on the transaction card. The RAM may also store a list of international (INTL) issuers of cards by their BIN number and a list of the billing currency for that INTL issuer. For the INTL issuer 132459, the issuer 4 may invoice the cardholder 1 in a currency that is not supported by the card scheme administrator 5 so that DCC may not be offered to the cardholder 1. Of course, the RAM may store no entry for the BIN number 132459 with the same effect.

Those skilled in the relevant arts will appreciate that some information shown in the table 9 may be stored outside of the POS terminal 7, which may receive the information as required to perform a transaction. For example, a list of DOM issuers may be stored at the POS terminal 7, whereas the list of INTL issuers and the billing currency associated with each INTL issuer may be stored remote from the POS terminal 7, for example in a database of the Acquirer 3. Also, further information may be included in the RAM of the POS terminal 7.

The present invention may include all or part of any of the exemplary methods described herein. In addition, the present invention may extend to methods including options described herein for one method applied to another method where that option is not inconsistent with the other method.

Where in the foregoing description reference has been made to specific integers or components having known equivalents, then those equivalents are hereby incorporated herein and individually set forth.

Those skilled in the relevant art would appreciate that modifications and additions may be made to the present invention without departing from the scope of the invention.

1. A method of performing a funds transaction that includes providing the option to perform the transaction using dynamic currency conversion, the method comprising
at a transaction terminal, receiving information that identifies an account and/or related information to an account;
using said information, determining whether the transaction is eligible for dynamic currency conversion;
if the transaction is eligible for dynamic currency conversion conducting the transaction in a nominated currency entered by an operator of the transaction terminal using an input device of the transaction terminal;
if the transaction is not eligible, performing the transaction in a default currency.

2. The method of claim 1, further including requiring the operator of the transaction terminal to specify whether or not dynamic currency conversion is to be performed before allowing the transaction to proceed.

3. The method of claim 2, wherein the default currency is the nominated currency of a merchant operator of the transaction terminal.

4. The method of claim 3, wherein at least part of the information that identifies an account and/or related information to the account is information either read by a reader of the transaction terminal or entered by the operator of the transaction terminal and the process of determining whether the transaction is eligible for dynamic currency conversion includes determining whether the card is issued by a domestic issuer and determining the transaction as not eligible if the card is issued by a domestic issuer.

5. The method of claim 4, further comprising requiring the cardholder to specify the nominated currency.

6. The method of claim 5, wherein the process of determining whether the transaction is eligible for dynamic currency conversion includes determining whether:
i) the nominated currency is the same as a billing currency of the card; and
ii) the billing currency of the card is supported,
wherein the transaction is determined to be not eligible if either i) or ii) is not satisfied.

7. Apparatus for performing a dynamic currency conversion transaction, the apparatus comprising a transaction terminal including a user interface, means to receive an identifier related to an account of a cardholder, and a communication interface for communicating with a network, wherein the transaction terminal receives an identifier from the means to receive an account identifier and then: a) either: i) using the communication interface transmits particulars of a transaction and receives a communication reporting whether the transaction is eligible for dynamic currency conversion, and/or ii) compares the account identifier with a listing of account identifiers maintained in memory and determines from the listing whether the transaction is eligible for dynamic currency conversion; b) if the transaction is eligible for dynamic currency conversion and an input to the user interface indicates that dynamic currency conversion is required, initiates processing of the transaction in a nominated currency, wherein the nominated currency has been received as an input to the user interface of the terminal; c) if the transaction is not eligible for dynamic currency conversion or if an input to the user interface indicates that dynamic currency conversion is not required, initiates processing of the transaction in a default currency.

8. The apparatus of claim 7, wherein processes b) and c) require receipt of an input from the user interface indicating whether dynamic currency conversion is required before processing the transaction.

9. The apparatus of claim 7, wherein the transaction terminal compares the account identifier with a listing of account identifiers maintained in memory and determines from the listing whether the transaction is eligible for dynamic currency conversion and wherein the step of determining comprises comparing the account identifier with a list of domestic issuers stored in the memory and if there is a
match with any entry in the list, determining that the transaction is not eligible for dynamic currency conversion.

10. The apparatus of claim 7, wherein the transaction terminal compares the account identifier with a listing of account identifiers maintained in memory and determines from the listing whether the transaction is eligible for dynamic currency conversion, wherein the transaction terminal stores in memory information identifying international issuers for which the billing currency of the issuer is a supported dynamic currency conversion currency, and wherein step of determining comprises determining whether the account identifier is associated with a said international issuer and if so determining that the transaction is eligible for dynamic currency conversion.

11. The apparatus of claim 10, wherein if the account identifier is not associated with a said international issuer, the transaction terminal requires additional user input at the user interface.

12. The apparatus of claim 11, wherein the additional user input is the identification of another nominated currency.

13. Apparatus for performing a dynamic currency conversion transaction, the apparatus comprising a computer in communication with a network, the computer operable to receive particulars of a transaction from a transaction terminal via said network, determine whether the transaction is eligible for dynamic currency conversion, and if so transmit onto the network data addressed to the transaction terminal a communication reporting whether the transaction is eligible for dynamic currency, the communication not including information identifying any particular country or currency.

14. The apparatus of claim 13, wherein the computer determines whether the transaction is eligible for dynamic currency conversion by comparing an identifier of an account involved in the transaction with entries stored in computer memory.

15. The apparatus of claim 14, wherein the entries stored in computer memory list identifiers of accounts that are eligible for dynamic currency conversion due to the local currency of the account holder matching a billing currency of the account holder for the transaction.

16. The apparatus of claim 15, wherein the transaction particulars include information identifying a nominated country or currency and wherein the computer determines whether the transaction is eligible for dynamic currency conversion by comparing the nominated country or currency with the local currency associated with the account holder.

17. A method of operating a transaction terminal to facilitate dynamic currency conversion of a transaction, the method comprising:
receiving at the transaction terminal data identifying currencies accepted for dynamic currency conversion;
at a transaction terminal, receiving particulars of a requested transaction, including an amount of a transaction in a first currency and identification of another currency for the transaction, wherein the identification of the other currency is received via an operator interface of the transaction terminal;
in the transaction terminal determining whether the transaction is eligible for dynamic currency conversion, including comparing the other currency with the accepted currencies and if the transaction is eligible converting the amount of a transaction in the first currency into a transaction amount in the other currency, and transmitting data for completing the requested transaction onto a network, the transmitted data including the transaction amount in the other currency.

18. A method of performing a funds transaction that includes providing the option to perform the transaction using dynamic currency conversion, the method including performing the following processes within a transaction terminal: receiving account information identifying an account and/or related information to an account; using the account information, determining whether the information identifies a domestic account and if the account information identifies a domestic account, performing the transaction in a default currency; if the account information identifies an international account, determining whether the transaction is eligible for dynamic currency conversion;
if the transaction is eligible for dynamic currency conversion, causing the display on a display of the transaction terminal a dynamic currency conversion offer and monitoring an operator interface of the transaction terminal for an indication of whether the offer is accepted and if so facilitating completion of the transaction using dynamic currency conversion; if the nominated currency is not supported or if the dynamic currency conversion offer is not accepted, performing the transaction in a default currency.

19. Apparatus for performing a dynamic currency conversion transaction, the apparatus comprising a transaction terminal including a user interface, means to receive an identifier related to an account of a cardholder, and a communication interface for communicating with a network, wherein the transaction terminal receives an identifier from the means to receive an account identifier and then: a) compares the identifier with a listing of domestic accounts and performs the transaction in a default currency if the identifier is determined to be associated with a domestic account; b) if process a) indicates that the identifier is not associated with a domestic account then either: i) using the communication interface transmits particulars of a transaction and receives a communication reporting whether the transaction is eligible for dynamic currency conversion, and/or ii) compares the account identifier with a listing of account identifiers maintained in memory and determines from the listing whether the transaction is eligible for dynamic currency conversion; and if the transaction is eligible for dynamic currency conversion and an input to the user interface indicates that dynamic currency conversion is required, initiates processing of the transaction using dynamic currency conversion; and if the transaction is not eligible for dynamic currency conversion or if an input to the user interface indicates that dynamic currency conversion is not required, initiates processing of the transaction in the default currency.

20. A method of performing a transaction that includes providing the option to perform the transaction using dynamic currency conversion, the method comprising at a transaction terminal, receiving information that identifies an account and/or related information to an account; and conducting the transaction in a nominated currency entered by an operator of the transaction terminal using an input device of the transaction terminal.

21. Apparatus for performing a dynamic currency conversion transaction, the apparatus comprising a transaction terminal including a user interface, means to receive an identifier related to an account of a cardholder, and a communication interface for communicating with a network, wherein the transaction terminal receives an identifier from the means to receive an account identifier and then initiates processing of the transaction in a nominated currency, wherein the nominated currency has been received as an input to the user interface of the terminal.

22-23. (canceled)

24. The method of claim 1, wherein the default currency is the nominated currency of a merchant operator of the transaction terminal.

25. The method of claim 1, wherein at least part of the information that identifies an account and/or related information to the account is information either read by a reader of the transaction terminal or entered by the operator of the transaction terminal and the process of determining whether the transaction is eligible for dynamic currency conversion includes determining whether the card is issued by a domestic issuer and determining the transaction as not eligible if the card is issued by a domestic issuer.

26. The method of claim 1, further comprising requiring the cardholder to specify the nominated currency.

27. The method of claim 1, wherein the process of determining whether the transaction is eligible for dynamic currency conversion includes determining whether:
i) the nominated currency is the same as a billing currency of the card; and
ii) the billing currency of the card is supported,
wherein the transaction is determined to be not eligible if either i) or ii) is not satisfied.
